(19) United States
(12) Patent Application Publication
(10) Pub. No.: US 2004/0018271 A1
(43) Pub. Date: Jan. 29, 2004

(54) Mold clamping mechanism for injection molding machine

(75) Inventors: Mitsushi Yoshioka, Yamanashi (JP); Masatoshi Senga, Yamanashi (JP)

Correspondence Address: STAAS & HALSEY LLP, SUITE 700, 1201 NEW YORK AVENUE, N.W., WASHINGTON, DC, 20005, US

(73) Assignee: FANUC LTD., Yamanashi (JP)

(21) Appl. No.: 10/462,804

(22) Filed: Jun. 17, 2003

(30) Foreign Application Priority Data
Jul. 23, 2002 (JP) 213483/2002

(51) Int. Cl. B29C 45/66

(52) U.S. Cl. 425/595

(57) ABSTRACT

A mold clamping device suitable for use in a small injection molding machine and manufacturable with low cost in which a sufficient clamping force is obtained by small number of parts. A link mechanism having a first link member and a second link member is provided between a rear platen and a movable platen. One end and the other end of the first link member are pivotally connected to the movable platen and the second link member, respectively. The second member is connected to the rear platen to be linearly movable with one end slidable along a linear guide provided at the rear platen. A stationary member of a linear motor is arranged at the rear platen and a movable member of the linear motor is provided at the second link member to surround the stationary member. The second link member is linearly moved by the linear motor to expand and fold the link mechanism so that mold halves attached to the stationary platen and the movable platen, respectively are closed to be clamped and opened to be unclamped.

### BACKGROUND OF THE INVENTION

1. Field of the Invention

The present invention relates to a mold clamping mechanism for an injection molding machine.

2. Description of Related Art

As a mold clamping mechanism for an injection molding machine, there are known a direct-clamp type in which a driving power of a drive source, such as an electric motor, is directly applied to a movable platen, a toggle type in which the driving power is applied to the movable platen through a single or double toggle mechanism, and a crank type in which the driving power is applied to the movable platen through a crank mechanism, so that mold halves attached to the movable platen and a stationary platen, respectively, are closed to be clamped and opened to be unclamped.

A rotary motor is generally employed as the driving source of the mold clamping mechanism and the rotary motion of the rotary motor is converted into a linear motion using a ball screw/nut mechanism and/or a rotational speed of the rotary motor is reduced using a speed reducer for driving the movable platen.

A mold clamping mechanism for a small injection molding machine has to be downsized and therefore has to be constituted by small parts. The small parts are generally of high cost since production amount of such parts are small. Further, there is a case where appropriate small parts are not be available. Thus, it is costly to downsize a mold clamping mechanism of a type which is constituted by a large number of parts, such as the double-toggle type. In view of the above, a mold clamping mechanism of the direct-clamp type which is constituted by small number of parts has been generally adopted for a small electric injection molding machine.

However, the mold clamping mechanism of the direct-clamp type using a ball screw/nut mechanism for converting the rotational motion into linear motion has problems that a speed of mold opening/closing is slow and that a large drive motor has to be used for securing a sufficient thrust force in mold locking up. Regarding the mold clamping mechanism of the crank type using a crank mechanism for converting a rotary motion of the rotary motor into a linear motion, this type of mold clamping mechanism requires a speed reducer and thus it is difficult to greatly reduce the number of parts.

### SUMMARY OF THE INVENTION

An object of the present invention is to provide a mold clamping mechanism suitable for use in a small injection molding machine and manufacturable with low cost in which a sufficient clamping force is obtained by small number of parts.

A mold clamping mechanism for an injection molding machine according to the present invention comprises: a stationary platen and a rear platen connected with each other by tie bars; a movable platen provided movable along the tie bars between the stationary platen and the rear platen; a link mechanism provided between the movable platen and the rear platen and including a first link member and a second link member, the first link member having one end pivotally connected to the movable platen and the other end pivotally connected to the second link member, and the second link member being connected to the rear platen to be linearly movable; and a liner motor for linearly moving the second link member.

The mold clamping mechanism may further comprise a first support member and a second support member projecting from one end and the other end, respectively, of the rear platen towards the movable platen, and a stationary member of the linear motor may be arranged between the first and second support members. The second link member may be bifurcated for the pivotal connection with the first link member, and a movable member of the linear motor may be arranged at a proximal portion of the bifurcation of the second link member to surround the stationary member of the linear motor. In this case, the stationary member of the linear motor may have a cylindrical shape and the movable member of the linear motor may have an annular shape into which the stationary member is inserted.

The rear platen may have a liner guide and a stationary member of the linear motor may be arranged at the rear platen to be parallel to the linear guide. The second link member may have a slider slidably connected with the linear guide of the rear platen and a movable member of the linear motor may be arranged at the second link member. In this case, the stationary member and the movable member of the linear motor may have plane shapes confronting each other.

### BRIEF DESCRIPTION OF THE DRAWINGS

FIG. 1 is a perspective view of a mold clamping mechanism according to a first embodiment of the present invention in a mold lock-up state;

FIG. 2 is a perspective view of the mold clamping mechanism in a mold full-open state;

FIG. 3 is an elevation view of the mold clamping mechanism in the mold lock-up state shown in FIG. 1;

FIG. 4 is an elevation view of the mold clamping mechanism in the mold full-open state shown in FIG. 2;

FIG. 5 is an elevation view of a mold clamping mechanism according to a second embodiment of the present invention in a mold lock-up state;

FIG. 6 is an elevation view of the clamping mechanism as shown in FIG. 5 in a mold full-open state; and

FIG. 7 is an enlarged plan view of the mold clamping mechanism as shown in FIG. 5 in the vicinity of a rear platen.

### DETAILED DESCRIPTION OF THE PREFERRED EMBODIMENTS

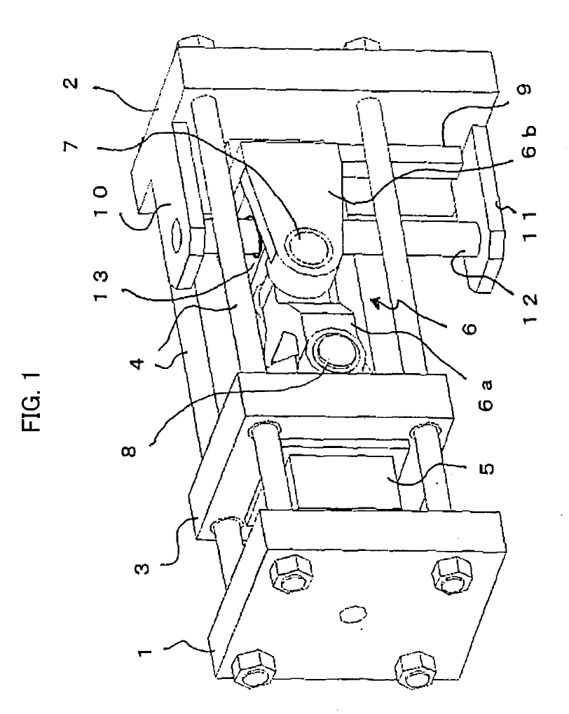

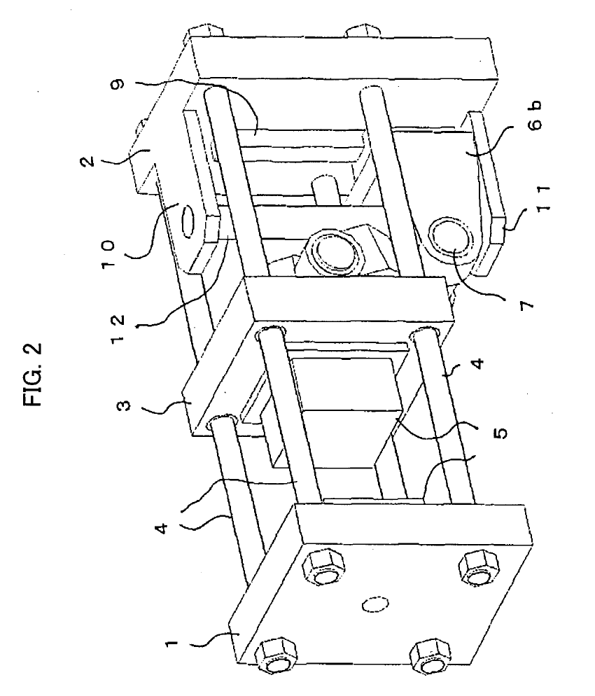

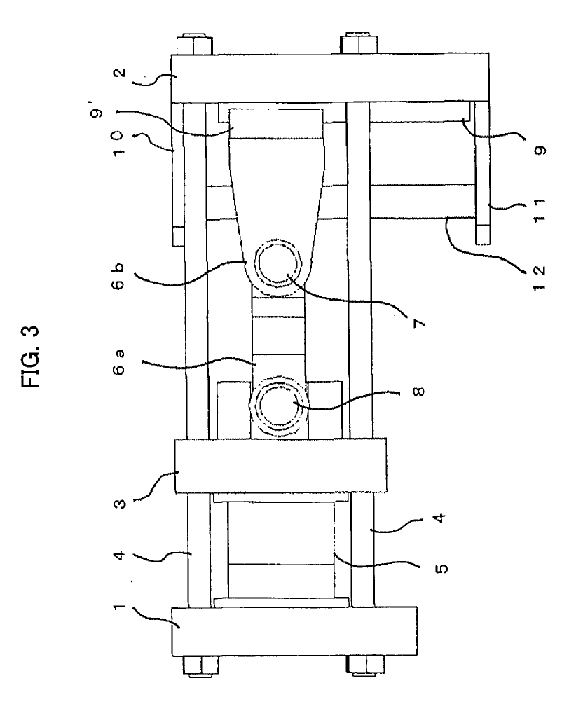

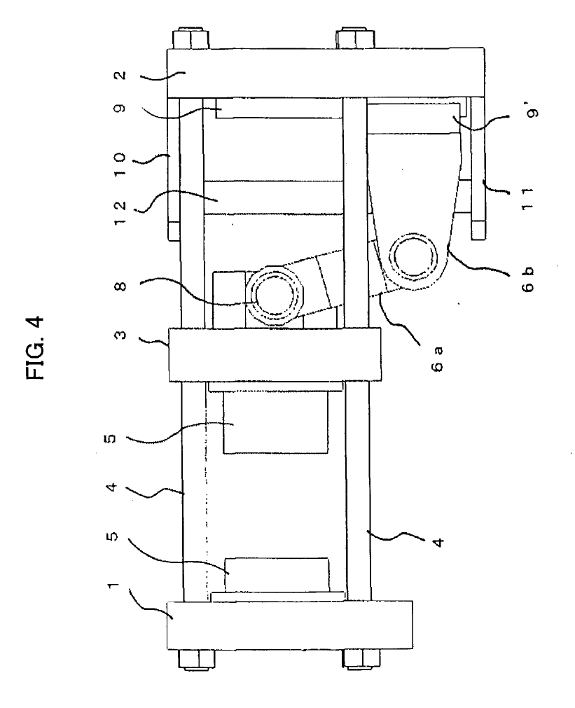

A mold clamping mechanism for an injection molding machine according to a first embodiment of the present invention will be described referring to FIGS. 1-4. FIGS. 1 and 3 show a mold lock-up state of the mold clamping mechanism, and FIGS. 2 and 4 show a mold full-open state of the mold clamping mechanism.

A stationary platen 1 and a rear platen 2 fixed to a base of an injection molding machine are connected with each other by a plurality of tie bars 4 (four tie bars in this embodiment). A movable platen 3 is arranged slidable along the tie bars 4 between the stationary platen 1 and the rear platen 2. A link mechanism 6 comprising a first link member 6a and a second link member 6b is provided between the movable platen 3 and the rear platen 2. One end of the link mechanism 6 is operatively connected to the movable platen 3 and the other end is operatively connected to the rear platen 2.

More specifically, an inner end of the first link member 6a and an inner end of the second link member 6b are pivotally connected with each other by a pin 7. An outer end of the first link member 6a is pivotally connected to the movable platen 3 by a pin 8. An outer end of the second link member 6b has a slider 9′ slidably connected to a linear guide 9 provided on the rear platen 2, so that the second link member 6b is moved linearly along the linear guide 9.

Support members 10 and 11 are provided at one end and the other end opposite to the one end, respectively, of the rear platen 2 to project towards the movable platen 3. In this embodiment, the support members 10 and 11 are provided at upper and lower ends, respectively, of the rear platen 2. The inner end of the second link member 6b is bifurcated for the pivotal connection with the inner end of the first member 6a. A cylindrical stationary member (a primary member comprising a coil) 12 of a linear motor is arranged between the upper support member 10 and the lower support member 11 to penetrate an proximal portion of the bifurcation of the second link member 6b. An annular movable member (a secondary member comprising a magnet) 13 of the linear motor is provided at the proximal portion of the bifurcation of the second link member 6b to surround the stationary member 12 of the linear motor, i.e., the cylindrical stationary member 12 is inserted into the annular movable member 13.

When the linear motor is driven to move the second link member 6b downwards along the linear guide 9 in the state as shown in FIG. 3, the link mechanism 6 is bent at the pin 7 with the first and second link members 6a and 6b folded, to move the movable platen 3 away from the stationary platen 1. Then, when the second link member 6b reaches the lowermost position as shown in FIGS. 2 and 4, mold halves 5 respectively attached to the stationary platen 1 and the movable platen 3 are fully opened. When the linear motor is driven in the reverse direction in the state shown in FIGS. 2 and 4, the second link member 6b is moved upward by being guided by the linear guide 9 to move the movable platen 3 towards the stationary platen 1. The second link member 6b is moved upward to reach the uppermost position as shown in FIGS. 1 and 3 so that the mold clamping mechanism enters into the lock-up state where the link mechanism 6 is expanded with the first link member 6a and the second link member 6b aligned on a straight line. In this lock-up state, the movable platen 3 is positioned closest to the stationary platen 1 to clamp the mold halves 5 between the movable platen 3 and the stationary platen 1.

As described, the movable platen 3 is moved towards/away from the stationary platen 1 by linearly moving the second link member 6b of the link mechanism 6 along the linear guide 9 on the rear platen 2 by the drive of the linear motor, so that mold halves 5 attached to the stationary platen 1 and the movable platen 3 are closed to be clamped and opened to be unclamped. Since the link mechanism 6 functions as a servo assistor of the driving force of the linear motor, a large clamping force is obtained.

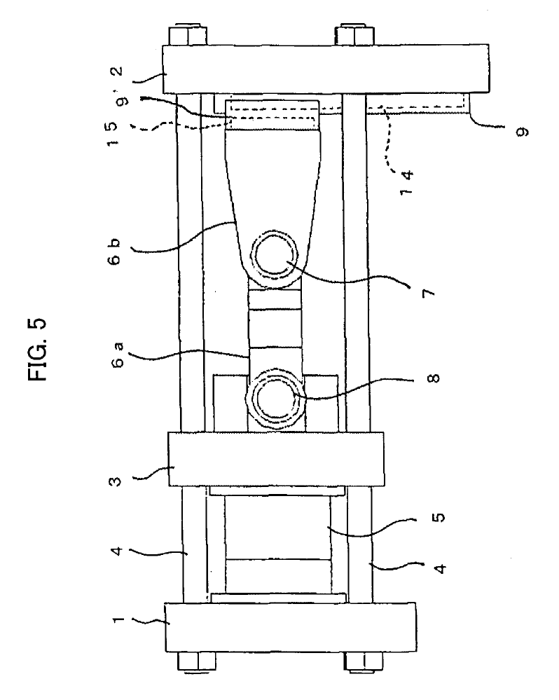

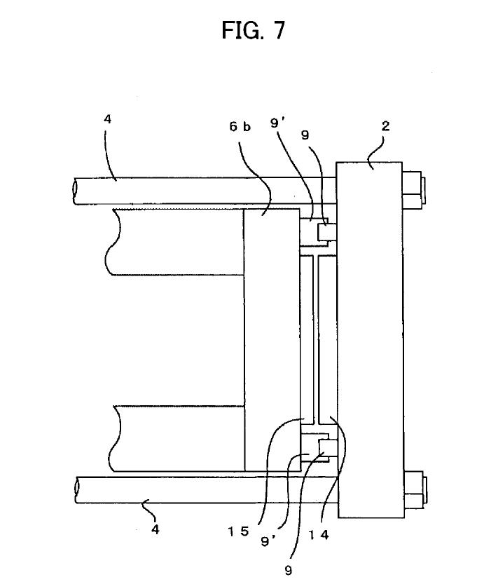

In the foregoing first embodiment, the linear motor comprising the cylindrical stationary member 12 and the annular movable element 13 is employed. Alternatively, a linear motor of a plane type may be employed. FIGS. 5-7 show a second embodiment in which the linear motor of a plane type is employed.

The second embodiment differs from the first embodiment in that the cylindrical stationary member 12 between the upper plate 10 and the lower plate 11, and the annular movable member 13 at the proximal portion of the bifurcation of the second member 6b are removed, and instead therefor a plane stationary member (a primary member comprising a coil) 14 of a linear motor is provided parallel to the linear guide 9 on the rear platen 2 and a plane movable member (a secondary member comprising a magnet) 15 of the linear motor is provided on the second link member 6b to confront the stationary member 14.

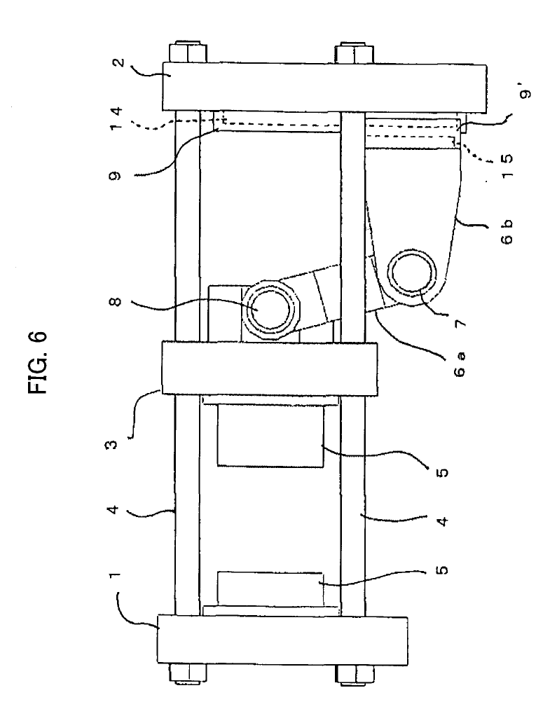

The second link member 6b is moved linearly with the slider 9′ sliding along the linear guide 9 on the rear platen 2 by driving the linear motor, to expand/fold the link mechanism 6. FIG. 5 shows a lock-up state of the mold clamping mechanism where the link mechanism 6 is expended to clamp the mold halves 5. FIG. 6 shows a full-open state of the mold clamping mechanism where the link mechanism 6 is folded to fully open the mold halves 5.

According to the present invention, the number of parts of the mold clamping mechanism is reduced since one of the link members of the link mechanism is directly driven by the linear motor and a sufficient clamping force is obtained by the linear motor of small size since the servo assisting function of the link mechanism is utilized, so that the mold clamping mechanism suitable for a small injection molding machine is provided with low cost.

What is claimed is:

1. A mold clamping mechanism for an injection molding machine comprising:
a stationary platen and a rear platen connected with each other by tie bars;
a movable platen provided movable along the tie bars between said stationary platen and said rear platen;
a link mechanism provided between said movable platen and said rear platen and including a first link member and a second link member, said first link member having one end pivotally connected to said movable platen and the other end pivotally connected to said second link member, and said second link member being connected to said rear platen to be linearly movable; and
a liner motor for linearly moving said second link member.

2. A mold clamping mechanism for an injection molding machine according to claim 1, further comprising a first support member and a second support member projecting from one end and the other end, respectively, of said rear platen towards said movable platen, wherein a stationary member of said linear motor is arranged between said first and second support members, said second link member is bifurcated for the pivotal connection with said first link member, and a movable member of said linear motor is arranged at a proximal portion of the bifurcation of said second link member to surround the stationary member of said linear motor.

3. A mold clamping mechanism for an injection molding machine according to claim 2, wherein said stationary member of said linear motor has a cylindrical shape and said movable member of said linear motor has an annular shape into which said stationary member is inserted.

4. A mold clamping mechanism for an injection molding machine according to claim 1, wherein said rear platen has a liner guide and a stationary member of said linear motor is arranged at said rear platen to be parallel to said linear guide, said second link member has a slider slidably connected with the linear guide of said rear platen and a movable member of said linear motor is arranged at said second link member.

5. A mold clamping mechanism for an injection molding machine according to claim 4, wherein said stationary member and said movable member of said linear motor have plane shapes confronting each other.
